(19) United States
(12) Patent Application Publication
(10) Pub. No.: US 2009/0001933 A1
(43) Pub. Date: Jan. 1, 2009

(54) Electric device system with integrated recharge source and exterior energy source

(76) Inventor: Chuang Long FU, Taipei (TW)

Correspondence Address: LADAS & PARRY LLP, 224 SOUTH MICHIGAN AVENUE, SUITE 1600, CHICAGO, IL, 60604, US

(21) Appl. No.: 12/027,352

(22) Filed: May 27, 2008

(30) Foreign Application Priority Data
Jun. 29, 2007 (EP) 07 290 829.6

(51) Int. Cl. H02J 7/00

(52) U.S. Cl. 320/112; 320/114

(57) ABSTRACT

A system containing an electric device such as a cellular phone, equipped with an integrated source of rechargeable electrical energy, an exterior energy source device and a connecting cable from the source device to the device. The exterior source device contains a module with several batteries likely to be connected t the device and constitute a source of electrical energy making it possible to completely charge the internal battery pack of the device.

The invention concerns a system of the type containing an electric device such as a cellular phone, equipped with an integrated rechargeable energy source, an exterior electrical energy source of the type with a battery and a connecting cable from the source to the device.

Systems of this type are already known, but have the shortcoming that the exterior electrical energy source constitutes only a supplemental source allowing the device to operate for only a limited time span.

The purpose of the invention is to overcome this shortcoming.

To achieve this goal, the system according to the invention is characterized by the fact that the exterior source is a device likely to contain multiple batteries enabling a complete charging of the internal battery pack.

The invention will be better understood, and its other purposes, characteristics, details and advantages will appear clearer upon the explanatory description to follow made in reference to the attached diagram drawings given only by way of example illustrating a way of carrying out the invention and in which:

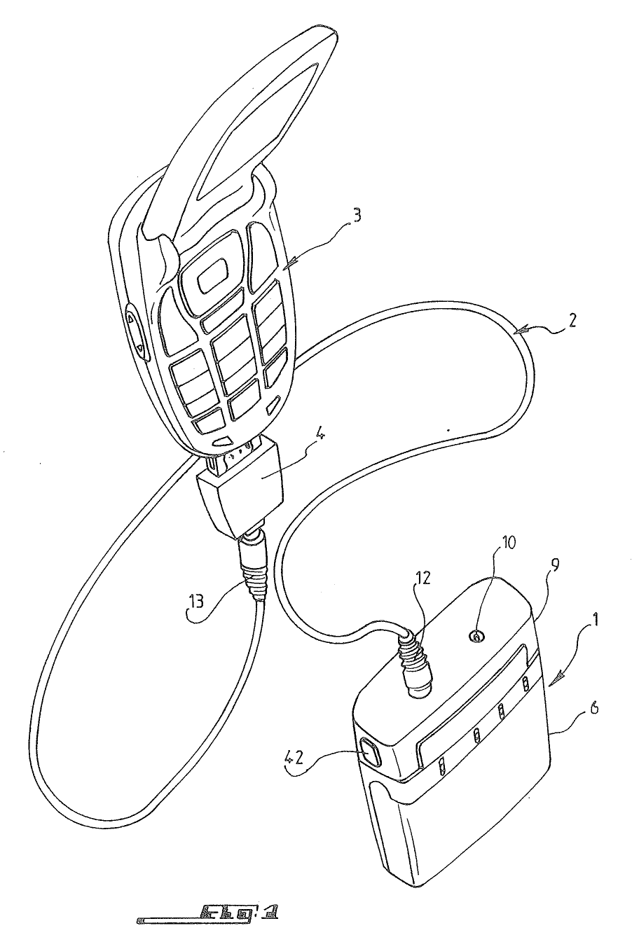

FIG. 1 is a perspective view of a system according to the invention containing a cellular phone connected to a rechargeable exterior electrical energy source device;

FIG. 2 is a perspective view showing the rechargeable electrical energy source device according to the invention mounted on a recharging device from the network;

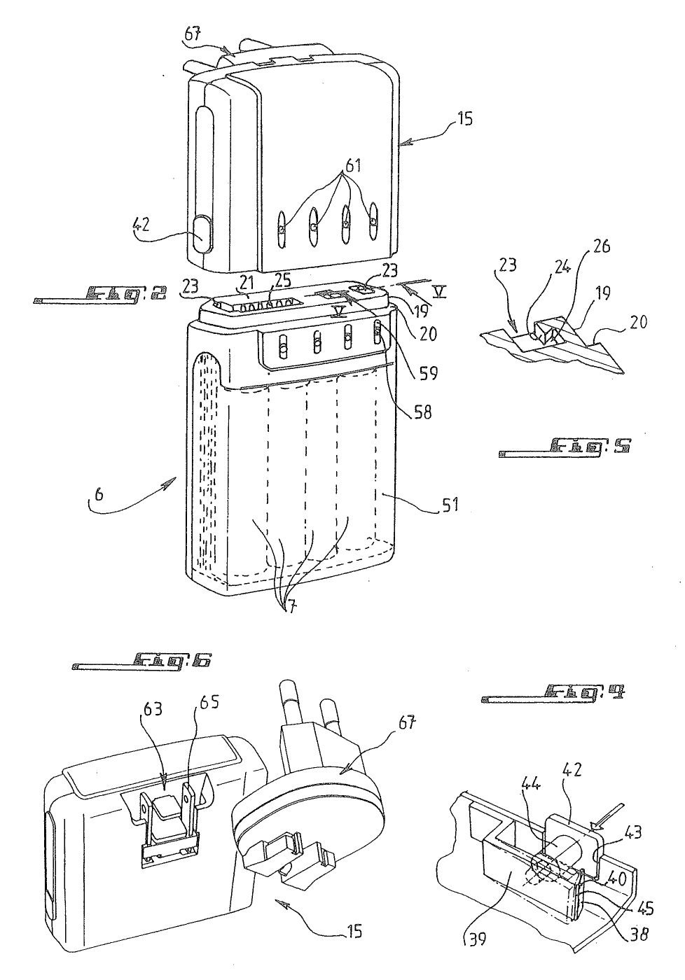

FIG. 3 is an exploded perspective view showing the different components of the system according to the invention, realized in the form of connectable modules;

FIG. 4 is a cross-sectional view according to line IV-IV of FIG. 3;

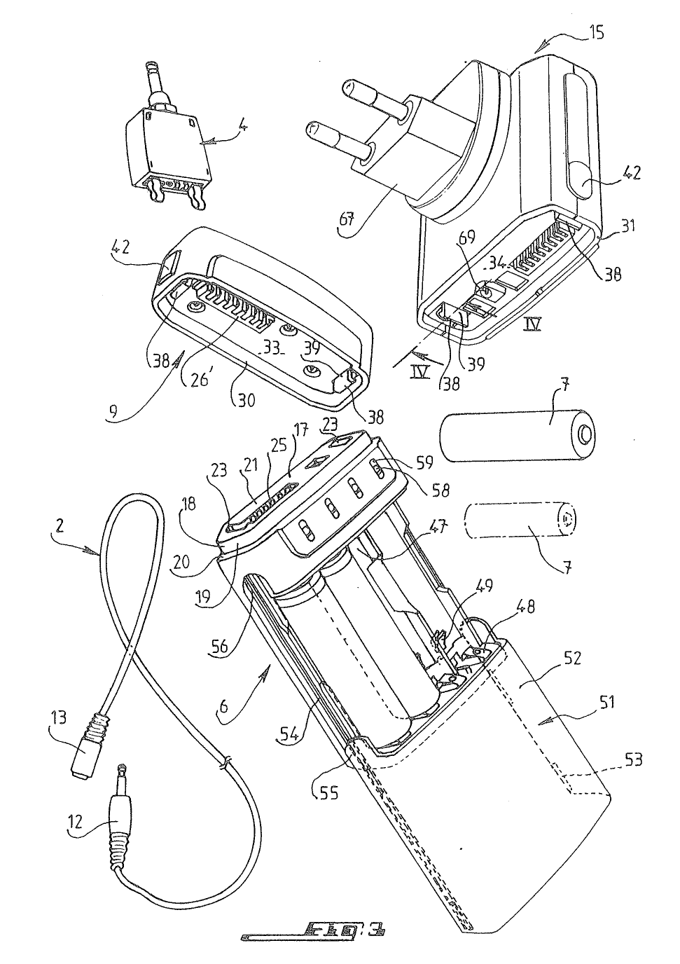

FIG. 5 is a cross-sectional view along line V-V of FIG. 2; and

FIG. 6 is an exploded perspective view of the charging device from the network, according to the invention.

The system according to the invention will be described below, by way of example, in its use to recharge the internal battery pack of a cellular phone. Of course, the system according to the invention can be used for any other electric-using device with compatible rechargeable internal battery pack.

In FIG. 1 a source of rechargeable autonomous electrical energy according to the invention, designated by reference 1 is connected by a connecting cable 2 to a cellular phone 3, via an adaptor connector 4 mediating between cable 2 and the cellular phone 3.

As we see in particular in FIG. 3, the autonomous electrical energy source device 1 contains two modules removably connectable using a rapid reversible fixation mechanism, that will be explained in detail further, namely a module 6 that houses appropriately rechargeable multiple batteries 7, 71 in the example represented four batteries, and an interface module 7, enabling the hook-up of cable 2 to source device 1. To that effect module 9 contains in FIG. 3 two receiving plugs 10 from the male connector 12 of cable 2 that is equipped with on its other end a universal connector 13 likely to be linked to the adaptor 4. It is shown in particular by FIG. 1, that the device is box-shaped, compact and esthetic, also like each of the two modules.

As FIG. 2 shows, the autonomous source device 1 is rechargeable and can be, to that effect, connected to a charging device 15 from the network, also realized in the form of a general box-shaped module whose dimensions correspond to those of source device 1, so that in the assembled condition, both modules constitute an esthetic regular parallelepiped assembly.

The assembling of the two modules is done using a similar rapid reversible fixation mechanism already mentioned above in the subject of the assembly of interface module 9 on module 6 of housing of the batteries. Thanks to the use of this same fixation mechanism, the interface module 9 and the recharging module 15 from the network are interchangeable concerning their assembly on module 6.

To secure the quick-release fastener, the end face 17 for receiving modules 9 and 15 has a crenellated profile created by a annular peripherally extending step 18 showing a noted peripheral face parallel to the axis of the module 19 and a peripheral annular face 20 perpendicular to the axis, faces 19 and 20 having a profile in the shape of a L. In the remaining flat end face 21, delineated by the recess 18 and slightly rectangular in shape, at each short side a cavity 23 is engaged, in the shape of a rectangle that extends up to a predetermined depth. As FIG. 5 shows, the side wall 24, adjacent to the short side of the recess 18 has an undercut 26. Furthermore, the end face contains an electrical connector 25 for connection to the additional electrical connector 26 of the charging module 15 and to the connector 26′ of the same type of the interface module 9.

For the fastening on this stepped edge 17 of module 6, the joining ends 28 and 29, respectively, of the interface module 9 and charging module 15 have a shape complementary to that of the joining end 17 of module 6. Both modules 9 and 15 include a peripheral axial rim 30 and 31, respectively, configured to be engaged in the peripherally extending step 18 of the joining end 17 of module 6. The indented end face 33 of the interface module 9 and the corresponding end face 34 of the charging module 15 are flat with the effect of coming in contact with the end surface 21 of module 6. From each end face 33, 34 the electrical connector 36, 36′ projects out, that secures, in cooperation with the female connector 25 of module 6 the electrical connection of the two assembled modules.

From each of the end faces 33, 34 of modules 9 and 15, at the short sides, elastically collapsible cramp-irons 38 project out, that are represented more in detail in FIG. 4. This figure shows that each cramp-iron 38 is equipped with on its exterior end a hook component 40. The opposite end of the clamp is bound to a foot 41 in the shape of an L that can be elastically separated from its slightly parallel orientation to the axis of the corresponding module, perpendicularly in the direction of the axis of the module, as that is illustrated by phantom lines in FIG. 4. This elastic lateral deflection can be manually controlled by pressure on an external button 42 arranged in an appropriate window 43 engaged in the exterior peripheral wall of module 9 or 15. The pressure exerted on the button is sent to the clamp 39 by a bond pad 44. It is again pointed out that the end face of each hook component 40 is in the shape of an inclined ramp 45.

Upon assembly on the energy source module 6 either of the interface module 9, or of the charging module 15, both the hooks 40 are engaged in one of the two cavities 23 in the assembling end face 23 of module 6. Upon engaging the hooks in the cavities, the slipping of the ramp surfaces 45 on the edge of the cavities brings about the elastic deflection of the clamps whose hooks 40 are next locked inside the cavities engaging in the undercuts 26.

Thus a quick-acting lock of the two modules on one another occurs.

This lock can be overcome and rendered reversible by manually pressing the external buttons 42, as indicated by the arrow in FIG. 4.

Concerning the structure of the modules, we observe that the module 6 of the source device includes a receiving compartment 47 for four 7 or 7′ batteries arranged next to each other, in parallel, between electrical contacts 48 concerning of the batteries 7 of normal length. For 7′ batteries shorter in length, the compartment provides for at its lower edge an electrical contact 49 out of phase from the electrical contact in the direction of the front upper end.

The compartment 47 for housing the batteries is fitted with a sliding transparent closure cover 51 in the shape of a U whose exterior edges of the branches 52 contain of the protruding components 53 likely to slide in of the appropriate grooves 54 provided in the exterior wall of compartment 47. The branches 52 of the cover contain at their front ends the tabs 55 designed to be engaged, in the closed position of the cover, in the additional recesses 56 at the front upper end of the module. In the front hollow part of the module the electrical connection components of the 7, 7′ batteries to the exterior connector 25 are arranged. Furthermore, we observe that above each battery is equipped with a movable switch slide component 58 in a window 59.

Glancing at FIG. 2, we observe that the charging module 15 from the network contains above each switch slide 58 a light-emitting diode 61 designed to indicate if the batteries 7, 71 are in the process of being charged.

Also of general box-shaped module 15 contains a known per se assembly device 63 removable by sliding on electrically conductive and swiveling pads 65 a male connector unit 67 from connection to the power network, that is known per se. In one alternative, the connector to the network could be permanently interdependent with module 15.

The operation and the use of the system according to the invention already illustrates the description that was just made, with reference to the figures. The autonomous electric source module 6 can be connected in the assembled condition 15 to the interface module 9, according to FIG. 1, via cable 2, to an electric device such as the cellular phone 3 represented. The module 6 can also be mounted on the charging module 15 to recharge the 7, 7′ batteries in the compartment 47 from the network. The device 3 can also be connected using cable 2 directly on the charging module 15. To that effect, you simply have to introduce the male connector 12 of the cable in the female component 69 provided in the joining surface 34 of this module. The autonomous source device 1 according to the invention, on account of multiple rechargeable or not batteries, that it can house, makes it possible to completely charge the internal battery pack of the device 3, contrary to the known devices that constitute only sources of supplemental energy. Thanks to its modular structure, its energy source module 6 can be directly connected either on the interface module 9 for connection to the device 3, or directly on the charging module 15. Thanks to the production of each module in the form of a parallelepiped body we obtain each time a compact and esthetic housing that is easy to assemble and disassemble using the quick-release fastening means that were described in detail. Each assembling of module 6 either to module 9 (FIG. 1), or to module 15 (FIG. 2) results in a compact, esthetic and easily maneuverable parallelepiped assembly.

1. A system comprising:
an electric device, equipped with an integrated source of rechargeable electrical energy,
an exterior electrical energy source device containing at least one rechargeable battery electrically connectable to the electric device and to a charging source of the battery,
wherein the exterior source device comprises a source module with said at least one battery, an interface module between the source module and the exterior source device, and a charging module from the battery of the source module,
wherein the interface and charging modules are mounted on the source module interchangeably, and
wherein the source module includes a single electrical connector for connection to an additional electrical connector of the charging module and to an interface module connector.

2. System according to claim 1, wherein the source module is box-shaped, including a frontal surface adapted for receiving the interface and charging modules, and containing the single electrical connector for connection to the interface and charging modules.

3. System according to claim 2, wherein the interface module is box-shaped and the interface module and the source module constitute, in an assembled condition, a compact parallelepiped assembly.

4. System according to claim 2, wherein the charging module is formed by a parallelepiped module that, assembled to the energy source module forms a compact parallelepiped assembly.

5. System according to claim 3, wherein the modules are assembled using quick-release and reversible fastening means.

6. System according to claim 5, wherein the quick-release and reversible fastening means are the type with elastically collapsible hook clamps, and with an undercut cavity.

7. System according to claim 3, wherein the source module includes a compartment for housing multiple batteries.

8. System according to claim 3, wherein the charging module includes a charging indicating means, associated with each battery of the source module.

9. System according to claim 4, wherein the modules are assembled using quick-release and reversible fastening means.

10. System according to claim 9, wherein the quick-release and reversible fastening means are the type with elastically collapsible hook clamps and with an undercut cavity.

11. System according to claim 9, wherein the source module includes a compartment for hosing multiple batteries.

12. System according to claim 9, wherein the charging module includes a charging indicating means, associated with each battery of the source module.
